(19) United States
(12) Patent Application Publication
(10) Pub. No.: US 2026/0112562 A1
(43) Pub. Date: Apr. 23, 2026

(54) HANDLE OF INDUSTRIAL CUT-OFF SWITCH WITH IMPROVED SAFETY USING MULTIPLE LOCKS

(71) Applicant: HYUNDAI TECH CO., LTD., Seoul (KR)

(72) Inventor: Jae Gyo JUNG, Seoul (KR)

(73) Assignee: HYUNDAI TECH CO., LTD., Seoul (KR)

(21) Appl. No.: 19/429,088

(22) Filed: Dec. 22, 2025

Related U.S. Application Data
(63) Continuation of application No. PCT/KR2024/008570, filed on Jun. 20, 2024.

(30) Foreign Application Priority Data
Jun. 20, 2023 (KR) 10-2023-0078727

(51) Int. Cl. H01H 71/04; H01H 71/10; H01H 71/60; H01H 71/02

(52) U.S. Cl. CPC H01H 71/04; H01H 71/1009; H01H 71/60; H01H 2071/0292

(57) ABSTRACT

The present invention relates to a handle of an industrial cut-off switch using multiple locks to improve safety, the handle being installed to actuate the industrial cut-off switch and comprising: a fixing unit formed on an outer surface of an enclosure of the industrial cut-off switch; and a rotation unit which is rotatable while covering one side of the fixing unit and is connected to a shaft unit extending from a switch unit inside the enclosure, and the rotation of which rotates the shaft unit, thereby changing the on/off state of the switch unit. The handle is provided with a plurality of locking means, and the rotation unit can rotate in one direction to the limit of the rotational range to change the switch unit to the on state when all of the provided locking means are unlocked.

### CROSS-REFERENCE TO RELATED APPLICATIONS

This application is a continuation of International Application No. PCT/KR2024/008570 filed on June 20, 2024, which claims priority to Korean Patent Application No. 10-2023-0078727 filed on June 20, 2023, the entire contents of which are herein incorporated by reference.

### TECHNICAL FIELD

The present disclosure relates to a handle for operating an industrial cut-off switch.

### BACKGROUND ART

In industrial sites, various work equipment such as electric motors may be used, and it is common to install and operate industrial cut-off switches nearby to supply or cut off current to this equipment.

An industrial cut-off switch is installed to safely control the supplied current and prevent accidents such as electric shock in the industrial sites, but despite this, safety accidents continue to occur.

For example, in the industrial sites, various noises are generated and communication between workers is often difficult. In such a case, the timing of supplying or interrupting the current due to the operation of the cut-off switch may deviate from the intended timing, and a safety accident may occur if a person other than the predetermined personnel operates the cut-off switch.

Accordingly, in order to solve the above-described problems, the inventor of the present disclosure conducted extensive research and repeated trials and errors, ultimately completing the present disclosure.

### DISCLOSURE OF THE INVENTION

### TECHNICAL GOALS

The present disclosure has been made in order to solve the problems described above, and an object of the present invention is to provide a handle of an industrial cut-off switch, which is provided with a plurality of locking means, wherein a rotation unit is able to rotate in one direction to the limit of its rotational operating range to change a switch unit to an on state when all of the provided locking means are unlocked.

Technical objects to be achieved by the present disclosure are not limited to the technical objects described above, and other technical objects not mentioned may be clearly understood by a person skilled in the art to which the present disclosure pertains from the description below.

### TECHNICAL SOLUTIONS

According to an aspect of the present disclosure for solving the above-described problems, there is provided an a handle which is installed to actuate an industrial cut-off switch, the handle including: a fixing unit formed on an outer surface of an enclosure of the industrial cut-off switch; and a rotation unit which is formed to be rotatable while covering one side of the fixing unit, is connected to a shaft unit extending from a switch unit inside the enclosure, and rotates the shaft unit together as the rotation unit turns, thereby changing the on/off state of the switch unit, wherein the handle is provided with a plurality of locking means, and the rotation unit is able to rotate in one direction to the limit of its rotational operating range to change the switch unit to the on state when all of the provided locking means are unlocked.

According to a preferred embodiment of the present disclosure, the rotation unit may be configured to be able to gradually rotate by a predetermined range by an external force whenever each locking means is unlocked, so that the degree of unlocking of the handle can be visually checked.

According to a preferred embodiment of the present disclosure, the switch unit may be switchable to the on state when all of the plurality of locking means are unlocked according to an unlocking sequence set for the plurality of locking means.

According to a preferred embodiment of the present disclosure, the fixing unit may include an inner locking ring in which a plurality of first locking holes are horizontally arranged to correspond to a curvature, the rotation unit may include an outer locking ring which is formed to cover the inner locking ring and in which second locking hole are horizontally arranged to correspond to the first locking holes, and a pair of the first locking hole and the second locking hole corresponding to each other may serve as one locking means and provide a locking function by using a locking device which is fastened in a state of passing through the pair of the first locking hole and the second locking hole.

According to a preferred embodiment of the present disclosure, whenever each locking means is unlocked, the inner locking ring may detect the unlocking and permit the rotation unit to rotate in one direction by a predetermined range, and as the rotation of the rotation unit is permitted, the inner locking ring may close the first locking hole of the most recently unlocked locking means each time the rotation unit rotates by the predetermined range in the one direction, and open the first locking holes in the reverse order of their closure each time the rotation unit rotates by the predetermined range in the opposite direction.

According to a preferred embodiment of the present disclosure, the industrial cut-off switch may be configured to be connected to an external power source when a door of the enclosure is in a closed state and to be cut off from the external power source when the door is in an open state, and may include a stopper device which opens the door when operated and keeps the door open, and the rotation unit may actuate the stopper device to open the door and cut off the external power when the rotation unit rotates in the opposite direction up to the limit of its rotational operating range.

### ADVANTAGEOUS EFFECTS

According to the present disclosure, since a plurality of locking means are provided and, when all of the provided locking means are released, the rotation unit is able to rotate in one direction up to the limit of its rotational operating range to switch the switch unit to the on state, managers may be assigned to the respective locking means, thereby enabling the industrial cut-off switch to be operated only in situations that require accurate supply or interruption of current.

The present disclosure has an effect of preventing malfunctions of the industrial cut-off switch due to communication errors among workers at an industrial site, thereby preventing safety accidents.

The present invention has an effect that, when a leakage occurs in the enclosure of the industrial cut-off switch, the door of the enclosure may be opened and the leakage may be interrupted by manipulating the handle in the opposite direction.

It should also be noted that any effects described in the following and any potential effects expected from the technical features of the present disclosure shall be regarded as being included in the present specification, even if the effects are not explicitly mentioned herein.

### BRIEF DESCRIPTION OF DRAWINGS

FIGS. 1 to 3 are reference diagrams for explaining a configuration in which a handle of an industrial cut-off switch according to the present disclosure is installed.

FIG. 4 is a reference diagram for explaining a specific configuration of a handle of an industrial cut-off switch according to the present disclosure.

FIGS. 5 to 7 are reference diagrams for explaining a leakage prevention configuration of a stopper device according to an embodiment of the present disclosure.

### MODES FOR CARRYING OUT THE INVENTION

In describing the present disclosure, detailed explanations of well-known functions that are apparent to those skilled in the art will be omitted when it is determined that such descriptions would unnecessarily obscure the gist of the disclosure.

The system of the present disclosure and the apparatus implementing the system may be implemented by a computer including one or more processors, memories, and the like. Examples of computers may include various devices such as personal computers, server computers, smartphones, tablets, and wearable devices. Here, the computer may be expressed as a user terminal, a service terminal, a service server, or the like, depending on users.

In the present specification, terms such as 'part', 'module', 'component', and 'interface' refer to computer-related entities and may mean hardware, a combination of hardware and software, or software. For example, the term 'communication unit' or 'communication module' may refer to hardware, a combination of hardware and software, or software that performs a communication function.

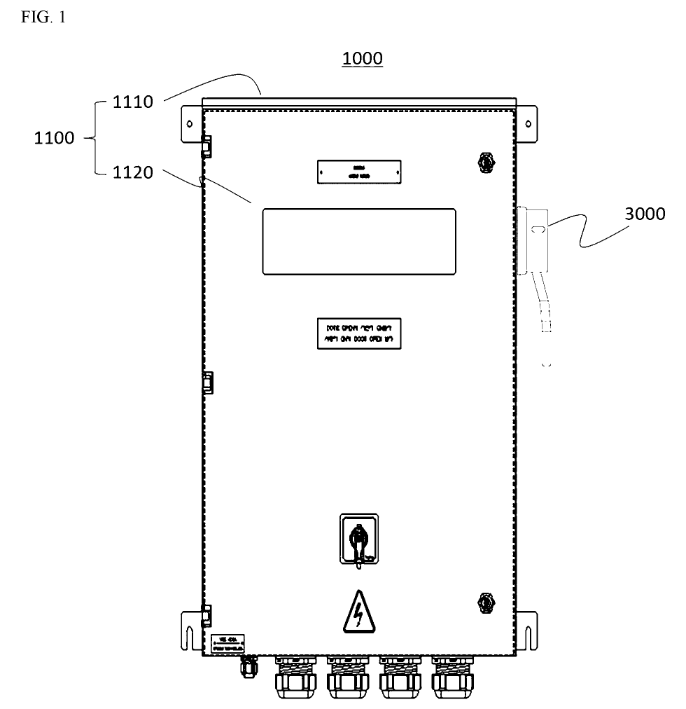

FIGS. 1 to 3 are reference diagrams for explaining a configuration in which a handle 3000 of an industrial cut-off switch 1000 according to the present disclosure is installed.

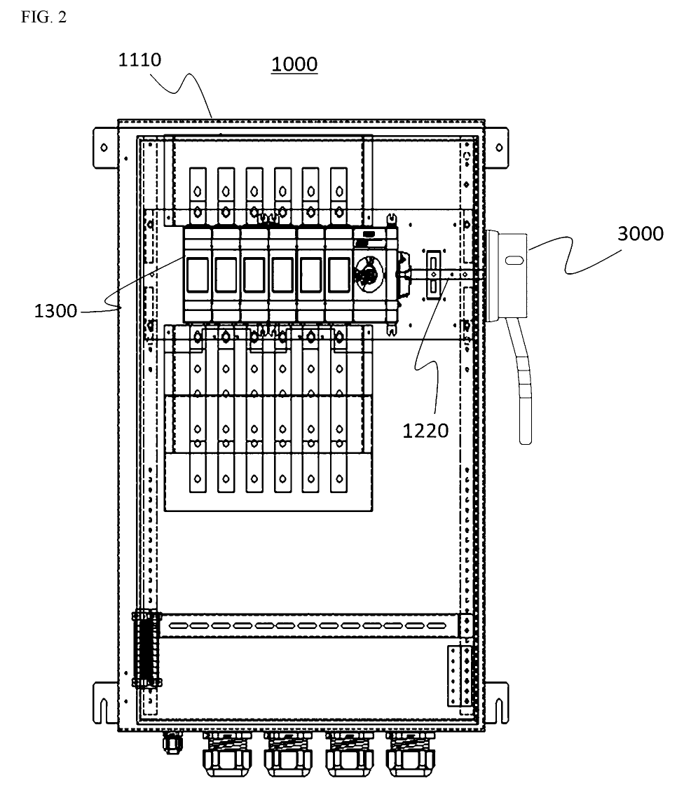

Specifically, FIG. 1 is a diagram illustrating the cut-off switch 1000 as viewed from the front. FIG. 2 is a diagram illustrating an internal configuration of the cut-off switch 1000.

Referring to FIGS. 1 and 2, the cut-off switch 1000 according to the present disclosure includes an enclosure 1100, the handle 3000, and a switch unit 1300, and further includes a shaft unit 1220 which connects the handle and the switch unit to transmit rotational force from the handle.

The handle 3000 is for controlling the switch unit 1300 inside the enclosure and may be disposed on an outer surface of the enclosure 1100. The handle 3000 has a shape extending in one direction so that it can be easily gripped by a user's hand. The handle 3000 is connected to the enclosure 1100 so as to be rotatable around a point at which it is attached to the outer surface of the enclosure 1100. The handle 3000 turns the switch unit 1300 on and off at predetermined rotational positions so that the user can easily recognize whether the switch unit 1300 is in the on or off state.

The switch unit 1300 is disposed inside the enclosure 1100 and is connected to the handle 3000 to perform on/off control of external power supply by means of manipulation of the handle 3000 disposed on the outer surface of the enclosure 1100. For example, the shaft unit 1220 may transfer rotational energy of the handle 3000 to the switch unit 1300 so that the on/off state of the switch unit 1300 is controlled.

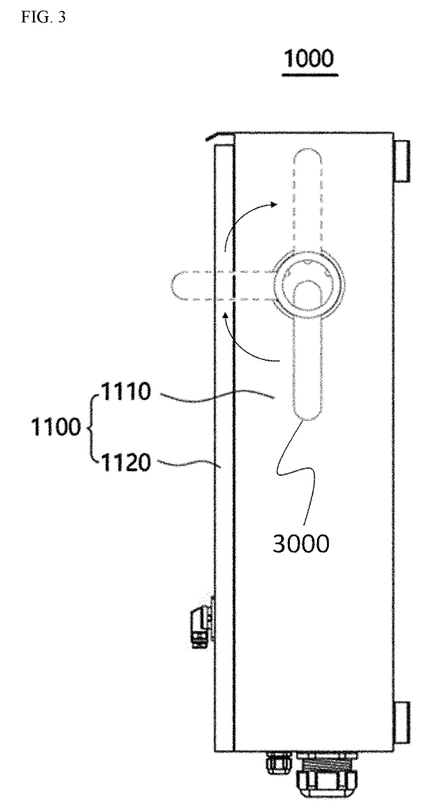

In addition, FIG. 3 is a diagram illustrating the cut-off switch 1000 as viewed from the side.

Referring to FIG. 3, the handle 3000 may change the switch unit 1300 to the on or off state at predetermined positions.

For example, the switch unit 1300 may be set to be in the off state when a gripping unit of the handle 3000 is oriented vertically downward with respect to the ground, and the switch unit 1300 may be set to be in the on state when the handle 3000 is rotated in one direction and the gripping unit of the handle 3000 is oriented vertically upward with respect to the ground. However, the method of changing the state of the switch unit according to the position of the handle 3000 is not limited to this, and may be changed and applied according to the environment in which the industrial cut-off switch is installed.

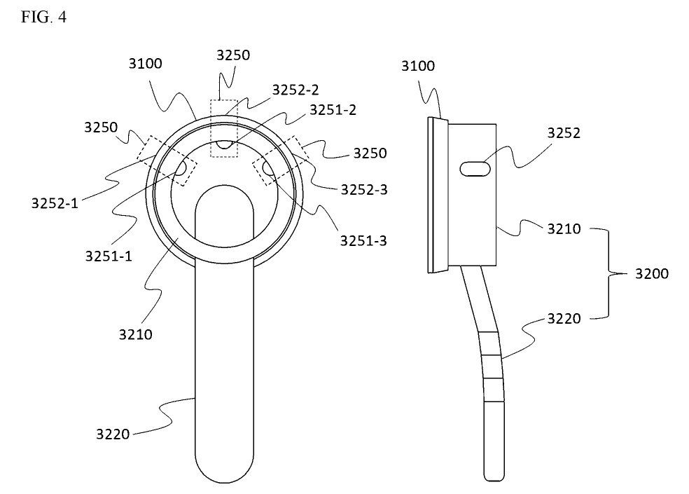

FIG. 4 is a reference diagram for explaining a specific configuration of the handle 3000 of the industrial cut-off switch 1000 according to the present disclosure.

Referring to FIG. 4, the handle 3000 includes a fixing unit 3100 formed on an outer surface of the enclosure 1100 of the industrial cut-off switch.

Further, the handle 3000 is formed to be rotatable while covering one side of the fixing unit 3100, and includes a rotation unit 3200 which is connected to the shaft unit 1220 extending from the switch unit 1300 inside the enclosure 1100 and rotates the shaft unit 1220 together as it rotates to change the on/off state of the switch unit 1300.

In addition, the handle 3000 is provided with a plurality of locking means 3250, and the rotation unit 3200 is formed such that it can be rotated in one direction to the limit of its rotational operating range to change the switch unit 1300 to the on state when all of the provided locking means 3250 are unlocked.

According to an embodiment of the present disclosure, the rotation unit 3200 is configured to be able to gradually rotate by a predetermined range by an external force whenever each locking means 3250 provided in the handle is unlocked, so that the degree of unlocking of the handle 3000 may be visually checked.

For example, as shown in FIG. 3, when the switch unit 1300 is set to be in the off state while the gripping unit of the handle 3000 is oriented vertically downward with respect to the ground, and the switch unit 1300 is set to be in the on state while the gripping unit of the handle 3000 is oriented vertically upward with respect to the ground, the total rotational movement range of the rotation unit 3200 becomes 180 degrees. Here, when a total of three locking means are provided, the rotation unit may be configured to be gradually rotatable by 60 degrees each time the lock of one locking means 3250 is unlocked.

In addition, the switch unit 1300 may be configured to be switchable to the on state when all of the plurality of locking means 3250 provided in the handle 3000 are unlocked according to a predetermined unlocking sequence set for the plurality of locking means 3250.

For example, when the handle is provided with a total of three locking means, a unique unlocking sequence may be set for each locking means. Specifically, if the locking means designated as the first priority is not unlocked first, the rotation unit 3200 of the handle cannot rotate at all. In such a case, all of the locking means may need to be returned to the locked state, and the unlocking operation must then be performed starting from the locking means designated as the first priority. Here, the unique unlocking sequence may be sensed by a sensor provided inside at least one of a first lock hole and a second lock hole which will be described below.

In addition, the fixing unit 3100 may include an inner locking ring in which a plurality of first locking holes 3251 are horizontally arranged to correspond to a curvature, and the rotation unit 3200 may include an outer locking ring 3210 which is formed to cover the inner locking ring and in which second locking hole 3252 are horizontally arranged to correspond to the first locking holes 3251. In this case, each locking ring may be fixed in place and only a gripping unit 3220 of the rotation unit 3200 may be configured to rotate by an external force, or the locking ring and the gripping unit 3220 may be configured to rotate together.

Here, a pair of the first locking hole 3251 and the second locking hole 3252 corresponding to each other constitute one locking means 3250, and may provide a locking function by using a locking device which is fastened in a state of passing through the pair of the first locking hole 3251 and the second locking hole 3252.

In addition, whenever each locking means 3250 is unlocked, the inner locking ring detects the unlocking and permits the rotation unit 3200 to rotate in one direction by a predetermined range. As the rotation of the rotation unit 3200 is permitted, the inner locking ring may close the first locking hole 3251 of the most recently unlocked locking means 3250 each time the rotation unit 3200 rotates by the predetermined range in the one direction, and open the first locking holes 3251 in the reverse order of their closure each time the rotation unit 3200 rotates by the predetermined range in the opposite direction. In such a case, in order to allow a worker to easily check the state of the locking holes, it is preferable that each locking ring be fixed in place and that only the gripping unit 3220 of the rotation unit 3200 be configured to rotate by an external force.

Accordingly, multiple users who intend to fasten the locking device to the locking means 3250 of the handle may avoid confusion regarding the position of the locking means which each user must lock after the completion of work at the industrial site.

For example, in the process of changing the switch unit 1300 from the on state to the off state, a specific first locking hole (one of 3151-1 to 3151-3) may be opened at each predetermined rotational range. Specifically, as shown in FIG. 4, when three locking means 3250 are provided in total and a first locking hole 3151-1 of the locking means 3250 including the first locking hole 3151-1 and a second locking hole 3152-1 is opened first during the process of switching the switch unit 1300 of the cut-off switch to the off state, the worker who performed the last unlocking operation may identify the locking means 3250 in which the first locking hole 3151-1 is opened and fasten the locking device which passes through the first locking hole 3151-1 and the second locking hole 3152-1. Subsequently, the worker who performed the intermediate unlocking operation may identify the opened first locking hole (3251-2 or 3251-3) and fasten the locking device thereto.

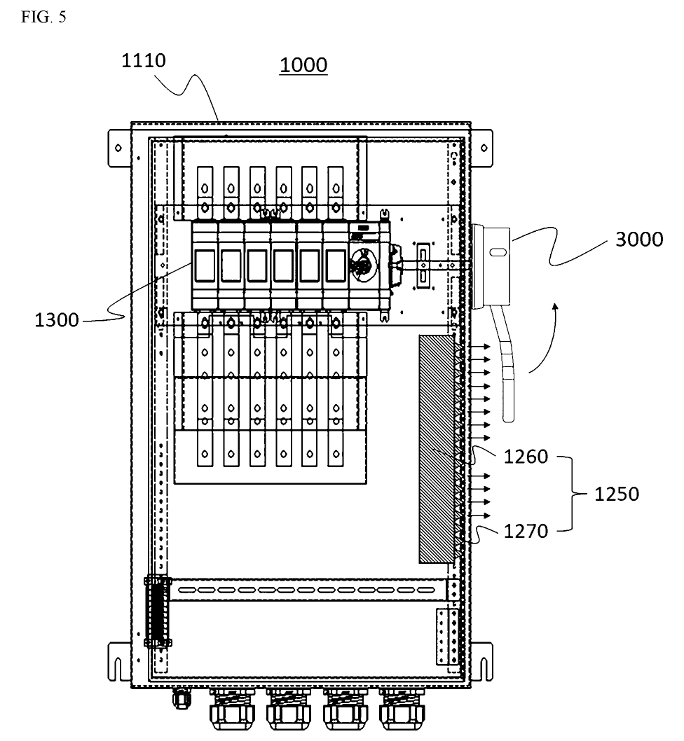

FIGS. 5 to 7 are reference diagrams for explaining a leakage prevention configuration of a stopper device 1250 according to an embodiment of the present disclosure.

The industrial cut-off switch 1000 according to the present disclosure may include a stopper device 1250 to prevent electric shock accidents caused by leakage.

Here, the industrial cut-off switch 1000 may be configured to be connected to an external power source when the door 1120 of the enclosure 1100 is in a closed state, and to be cut off from the external power source when the door 1120 is in an open state.

Referring to FIG. 5, the stopper device 1250 may be disposed adjacent to an end of another side of the main body 1110 where no hinge coupling with the door 1120 is formed, and when operated, a portion thereof may protrude outside the enclosure 1100 to maintain the door 1120 in the open state. From the moment the door 1120 is opened, the external power may be cut off, thereby preventing the risk of electric shock, but if the door 1120 is closed again during work, the user may be exposed to the risk of electric shock once more. Therefore, the stopper device 1250 keeps the door 1120 open to ensure that the external power is continuously cut off during work.

When the rotation unit 3200 of the handle 3000 rotates in the opposite direction up to the limit of its rotational operating range due to external pressure applied to the gripping unit 3220, the stopper device 1250 may be actuated to open the door and cut off the external power.

In addition, the handle 3000 may be made of a material such as rubber in order to minimize the risk of electric shock to the user and to provide a certain level of frictional force, thereby allowing the user to easily apply pressure and rotate the handle by performing a kicking motion or by using a bar-shaped tool.

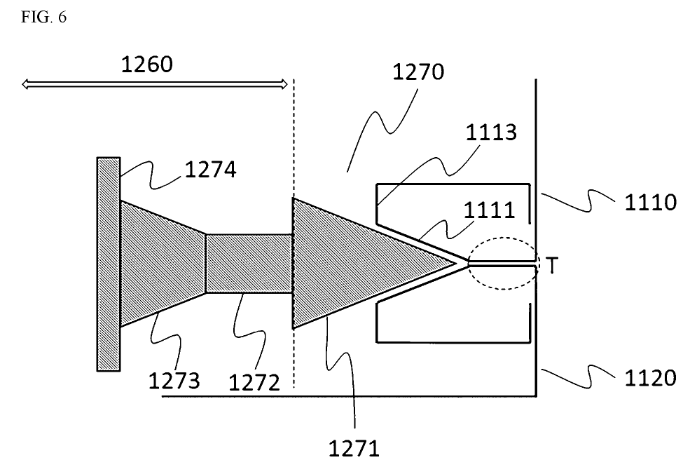

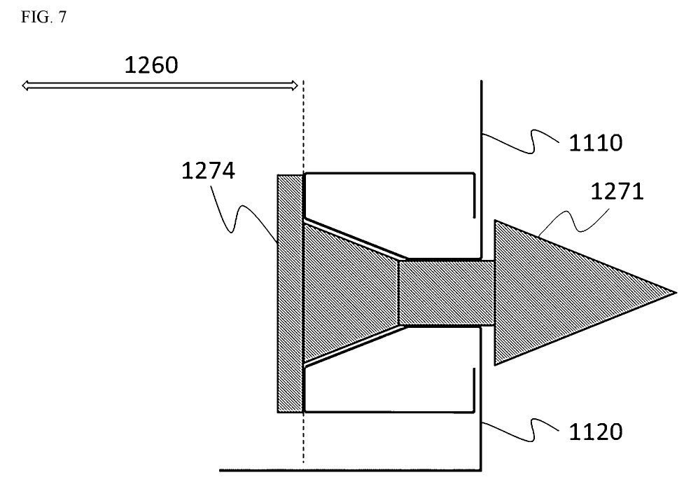

FIG. 6 and FIG. 7 are cross-sectional views viewed from above of the other side where no hinge coupling is formed between the main body 1110 and the door 1120. Referring to FIG. 6 and FIG. 7, the stopper device 1250 may include a stopper unit 1270 which advances toward contact surfaces T between the main body 1110 and the door 1120 on the other side when the stopper device 1250 is operated to separate the main body 1110 and the door 1120 from each other and to keep the door 1120 in the open state. Referring to FIG. 5, a plurality of the stopper units 1270 may be provided to stably maintain the open state of the door 1120, and may be arranged vertically along the contact surfaces T between the main body 1110 and the door 1120 on the other side.

Further, the stopper device 1250 may include a stopper driving unit 1260 which, when a trigger is activated by the rotation of the rotation unit 3200, uses an internal elastic device to propel the plurality of stopper units 1270 to advance toward the contact surfaces T between the main body 1110 and the door 1120 on the other side.

In addition, each of the main body 1110 and the door 1120 may be formed to include a guide portion 1111 and a fixing jaw 1113 configured to assist the operation of the stopper device 1250 at the end of the other side where no hinge coupling is formed.

Specifically, the stopper unit 1270 may be configured to include an entering portion 1271, a contact prevention portion 1272, a support portion 1273, and a braking portion 1274.

The entering portion 1271 may be formed in a shape to enter between the contact surfaces T of the main body 1110 and the door 1120 as the stopper unit 1270 advances, thereby separating the two contact surfaces T from each other. For example, the entering portion 1271 may be formed in a conical shape having an inclined surface.

The contact prevention portion 1272 is positioned to prevent the two contact surfaces T from making contact when the entry of the stopper unit 1270 through the entering portion 1271 is completed, thereby keeping the door 1120 in the open state.

The support portion 1273 serves to support a structure formed at the end of the other side where no hinge coupling is formed between the main body 1110 and the door 1120 so that the structure does not become deformed.

Specifically, the support portion 1273 may be formed to have an inclined surface with an inclination angle corresponding to that of the entering portion 1271. Accordingly, when the door 1120 rotates in a closing direction and collides with the stopper unit 1270, the guide portion 1111 may be stably supported, and a situation in which the shape of an end-side structure is deformed, such as the angle of inclination of the guide portion 1111 being distorted, may be prevented.

The braking portion 1274 plays a role in preventing the stopper unit 1270 from advancing any further by colliding with the end-side structure such as the fixing jaw 1113 described later. A rear surface of the braking portion 1274 may be directly or indirectly connected to the elastic device of the stopper driving unit 1260 to apply pressure so that the stopper unit 1270 is propelled.

The guide portion 1111, which is a structural component of the end, may be formed to have an inclined surface corresponding to the entering portion 1271 of the advancing stopper unit 1270, thereby reducing friction with the entering portion 1271, and may guide a tip of the entering portion 1271 to advance between the main body 1110 and the door 1120.

The fixing jaw 1113, which is a structural component of the end, may collide with the braking portion 1274 of the advancing stopper unit 1270 to limit a moving range of the stopper unit 1270 to a predetermined range, and allow the contact prevention portion 1272 of the operated stopper unit 1270 to be positioned between the contact surfaces T located at the end on the other side.

It will be apparent to those skilled in the art that the present disclosure may be embodied in various other specific forms without departing from the characteristics of the present disclosure. Accordingly, the above detailed description should not be construed as limiting in any respect and should be considered as illustrative. The scope of the present disclosure should be determined by a reasonable interpretation of the appended claims, and all changes within the equivalent scope of the present disclosure are included in the scope of the present disclosure.

1. A handle of an industrial cut-off switch using multiple locks to improve safety, which is installed to actuate the industrial cut-off switch, the handle comprising:
a fixing unit formed on an outer surface of an enclosure of the industrial cut-off switch; and
a rotation unit which is formed to be rotatable while covering one side of the fixing unit, is connected to a shaft unit extending from a switch unit inside the enclosure, and rotates the shaft unit together as the rotation unit turns, thereby changing an on/off state of the switch unit,
wherein the handle is provided with a plurality of locking means, and the rotation unit is able to rotate in one direction to a limit of its rotational operating range to change the switch unit to the on state when all of the provided locking means are unlocked,
wherein the rotation unit is configured to be able to gradually rotate by a predetermined range by an external force whenever each locking means is unlocked, so that a degree of unlocking of the handle is able to be visually checked.
wherein the fixing unit comprises an inner locking ring in which a plurality of first locking holes are horizontally arranged to correspond to a curvature,
the rotation unit comprises an outer locking ring which is formed to cover the inner locking ring and in which second locking hole are horizontally arranged to correspond to the first locking holes, and
a pair of the first locking hole and the second locking hole corresponding to each other serve as one locking means and provide a locking function by using a locking device which is fastened in a state of passing through the pair of the first locking hole and the second locking hole.

2. The handle of claim 1, wherein the switch unit is switchable to the on state when all of the plurality of locking means are unlocked according to an unlocking sequence set for the plurality of locking means.

3. The handle of claim 1, wherein, whenever each locking means is unlocked, the inner locking ring detects the unlocking and permits the rotation unit to rotate in one direction by a predetermined range, and
as the rotation of the rotation unit is permitted, the inner locking ring closes the first locking hole of the most recently unlocked locking means each time the rotation unit rotates by the predetermined range in the one direction, and opens the first locking holes in a reverse order of their closure each time the rotation unit rotates by the predetermined range in the opposite direction.

4. The handle of claim 1, wherein the industrial cut-off switch is configured to be connected to an external power source when a door of the enclosure is in a closed state and to be cut off from the external power source when the door is in an open state, and
comprises a stopper device which opens the door when operated and keeps the door open, and
the rotation unit actuates the stopper device to open the door and cut off the external power when the rotation unit rotates in the opposite direction up to the limit of its rotational operating range.
